(19) United States
(12) Patent Application Publication
(10) Pub. No.: US 2005/0198338 A1
(43) Pub. Date: Sep. 8, 2005

(54) Image data transfer sessions

(75) Inventors: Fehmi Chebil, Irving, TX (US); Asad Islam, Richardson, TX (US); Jari Selin, Espoo (FI); Pekka Pessi, Helsinki (FI); Jose Costa-Requena, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/019,939

(22) Filed: Dec. 21, 2004

(30) Foreign Application Priority Data
Dec. 23, 2003 (WO) PCT/IB03/06134

(51) Int. Cl. G06F 15/16; G06F 17/30

(52) U.S. Cl. 709/230; 707/10

(57) ABSTRACT

The present invention relates to the exchange of images and image related data between at least two end points 10, 11, 12, 13, in which exchange at least one wireless terminal 10, 11, 12 is a participating end point. The invention is based on the insight to use the Session Initiation Protocol as an upper layer protocol to enable usage of a client-server protocol that handles images, such that efficient transfer of image related data between a client 10, 11, 12 and a server 10, 11, 12, 13 is achieved. An embodiment of the invention is based on the further insight to use the Session Initiation Protocol as an upper layer protocol to enable usage of the JPIP protocol, which latter is a client-server protocol for handling images, such that efficient transfer of image related data between a client and a server is achieved.

### CROSS-REFERENCE TO RELATED APPLICATION

Priority is claimed under 35 U.S.C. 119 from International Application PCT/IB03/06134 filed Dec. 23, 2003.

### TECHNICAL FIELD OF THE INVENTION

The present invention relates to the exchange of images and image related data between at least two end points, in which exchange at least one wireless terminal is a participating end point.

### BACKGROUND OF THE INVENTION

The use of digitally stored images and the sharing of such images among different users is becoming increasingly popular. An image may be uploaded to a server by a user, or a company, and then be downloaded by a plurality of other users for viewing. For example, it is nowadays popular to share your personal digital photos with your friends by uploading them to a server for future downloading by other users. Moreover, with the introduction of the so called third generation of mobile telephone networks, and its third generation wireless terminals of which many have an integrated digital camera and a color display, the sharing of images among users and uploading/downloading of images to/from servers is expected to increase dramatically.

Until recently, an image has been regarded as represented by non-real-time data, in contrast to video which due to its moving pictures is regarded as real-time data. However, the increasing desire to share images between and among different users, and the introduction of wireless terminals with color display, and possibly integrated digital cameras, is about to change this.

It is now appreciated that storing, sharing and retrieval of images can be made in a more sophisticated way. Techniques have been developed for the exchange of image related data within a client/server relationship. This exchange of image data provides mechanisms for locating and retrieving parts of a digitally stored image from a server to a client. The client may then display and store the retrieved part. This also provides the possibility of “browsing” images, i.e. to successively locate and retrieve different parts of an image. Such browsing e.g. being suitable for viewing a large image with a small display of a wireless terminal without compromising the resolution of the image. The image data can then be regarded as being streamed as real-time data to the recipient, since it is of importance that the browsing can be performed in a smooth and continuous manner. It can at the same time be regarded as an “interactive” way of viewing an image.

An example of a protocol designed for the exchange of image related data within a client/server relationship is JPIP (JPEG 2000 Interactive Protocol), which currently is subject to standardization. JPIP is a protocol designed to provide access and transmission of JPEG 2000 coded data and related metadata in a networked environment. It consists of a structured series of interactions between a client and a server by means of which image file metadata, structure, and partial or whole image codestreams may be exchanged in an efficient manner. JPIP defines the semantics and the values to be exchanged using a variety of existing network transport protocols, including TCP, UDP and HTTP. JPIP is to be used by applications for image browsing, image surfing, image or metadata retrieval, and image uploading. For more information on JPIP, reference is made to part 9 of the JPEG 2000 standard prepared by ISO/IEC and ITU-T and currently available on www.jpeg.org.

A problem with a protocol of the kind described above for exchanging of image related data, to enable interactive image data transfer between two end points, is that it defines a session which needs to be initiated, established, possibly modified, and then terminated. Also the JPIP session needs to be initiated, established, modified, and terminated, in order to efficiently implement the exchange of image related data between two end points, i.e. between a server and a client.

A typical use-case scenario of the JPIP standard would be a client connecting to an image server and interactively browsing the residing images. To illustrate the usage of JPIP, the standard suggests an application of JPIP on HTTP. The server in such an application is an HTTP server. The client would connect to the HTTP server using the HTTP based requests (GET and POST) appended by JPIP requests. The client would interactively browse images (downloading image data) and uploading images. The HTTP server filters the incoming request for any JPIP-specific parameters and activates the JPIP stack to interpret and process the JPIP-specific request.

While the above scenario could be useful for browsing images on HTTP servers, it cannot be used for accessing other image servers that are not HTTP-enabled. For instance, if a user wants to browse the images at his PC, he would have to have the PC running as an HTTP server. Similarly, users may want to download and view images residing on other devices, for instance, mobile phones, which then would need to be configured as HTTP servers.

Another application of JPIP given by the standard is to use it on top of TCP or UDP as transport protocol for the JPIP data. While such an application would require less constraints than setting up the server as an HTTP server, it still lack the upper layer signaling protocol which would:
initiate a session between the client and the server. Inform the client about the images existing in the server;
allow the client to indicate its capabilities to the server and renegotiate them; and
offer the image data transfer feature within a framework supporting other media types in its services, such as audio, video, text, etc.

### SUMMARY OF THE INVENTION

The present invention provides a method, a system and a terminal which enable efficient transfer of image related data using a client-server protocol that handles images.

The idea of the present invention is to manage images and image related data by means of an established Session Initiation Protocol, SIP, session between at least two end points, of which at least one end point is a wireless terminal. A multimedia session for image data exchange is then initiated within the SIP session.

Thus, the invention is based on the insight to use the Session Initiation Protocol as an upper layer protocol to enable usage of a client-server protocol that handles images, such that efficient transfer of image related data between a client and a server is achieved.

An embodiment of the invention is based on the further insight to use the Session Initiation Protocol as an upper layer protocol to enable usage of the JPIP protocol, which latter is a client-server protocol for handling images, such that efficient transfer of image related data between a client and a server is achieved.

Once a SIP session has been established, a JPIP session, or a corresponding interactive image data transfer session, will define the mechanism for exchanging image related data. Thus, using a SIP session, JPIP clients can establish, modify and terminate image browsing, image surfing, image transfer or image uploading sessions.

The image data transfer is interactive, which means that a client and a server communicate in an interactive manner to exchange requests and services, i.e. responses to requests, regarding the content of an image. In contrast, traditional image sharing is not interactive since it involves a one-time, one-way transfer from a server to a client. The client acts as a passive terminal and cannot interact with the server to send requests regarding the image. Further, such traditional image sharing is not performed in real-time, but is done off-line, i.e. the server transmits the image to the client, which retrieves and views the image at a time of its own convenience. Thus, there is no ongoing real-time session between the server and the client.

The use of SIP in combination with JPIP also means that JPIP can form part of a SIP based rich call session, i.e. a session in which other media, such as voice, can be added and enrich the interactive experience. For example, audio can be used for requesting, and transferring, voice comments related to an image or a specific portion of an image, thereby enhancing the user's experience.

The present invention allows multimedia devices, such as wireless terminals, to act as host servers for sharing images with other devices. The host devices need not be HTTP servers; rather, they only need to be JPIP-enabled having SIP user agents. Hence, the invention opens up a new world for image sharing where practically any multimedia device would be capable of sharing images with other devices by acting as the host device.

Interactive image sharing, using JPIP/SIP-based call sessions, especially enhance the experience of image sharing when wireless terminals having limited display capabilities are involved. Image sharing can be done in a number of established ways in varying situations and with different objectives. The underlying principle of the invention is that SIP-based Rich Call sessions are initiated to establish the necessary session between the participants, while a JPIP-based data transfer mechanism is used to transfer and share images and image-related data between the participating terminals.

The present invention provides any client or host server with the ability to establish a JPIP-based multimedia session for efficient and interactive image data exchange. Moreover, it allows any number of clients to join an ongoing session to share the experience of the rich multimedia content distribution.

### BRIEF DESCRIPTION OF THE DRAWINGS

Exemplifying embodiments of the present invention will be described with reference to the accompanying drawings, in which:

FIG. 1 shows an exemplified system in accordance with the invention in which exemplifying embodiments of the invention are operable;

FIG. 2 illustrates a user referring another user to a stored image;

FIG. 3 illustrates one-to-one image sharing;

FIG. 4 illustrates one-to-one image sharing within an existing SIP session;

FIG. 5 illustrates image upload to a server;

FIG. 6 illustrates image sharing in a conference using an image upload method;

FIG. 7 illustrates image sharing using a conference server as a proxy;

FIG. 8 illustrates a call session mechanism used in FIG. 9;

FIG. 9 illustrates a host-initiated host-controlled image surfing session;

FIG. 10 illustrates a call session mechanism used in FIG. 12;

FIG. 11 illustrates an alternative call session mechanism used in FIG. 12;

FIG. 12 illustrates client-controlled image surfing;

FIG. 13 a call session mechanism used in FIG. 14; and

FIG. 14 illustrates client-initiated dedicated-server image browsing and surfing.

### DETAILED DESCRIPTION OF THE INVENTION

Exemplifying embodiments of the present invention will now be described in more detail. These embodiments will mainly be described with reference to the JPIP protocol as the image data transferring protocol, and it will be shown how to add support for JPIP data transfer to the SIP protocol.

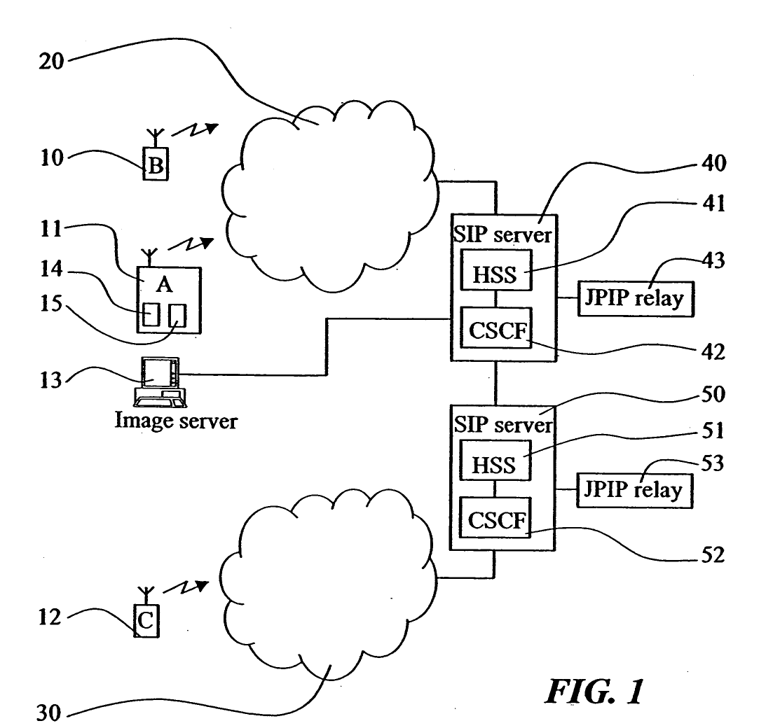

FIG. 1 schematically shows an exemplified system in accordance with the invention in which exemplifying embodiments of the invention are operable. The system includes a number of wireless terminal 10, 11 and 12, also denoted A, B and C, operably connected to different radio communications networks 20 and 30. Terminals 10 and 11 communicate via radio communications network 20, which network in turn is connected to a SIP server 40. As shown, a host server 13 may also be connected to the SIP server 40. Terminal 12 communicate via radio communications network 30, which in turn is connected to another SIP server 50. The two SIP servers 40 and 50 are operably interconnected.

Each SIP server 40, 50 includes a HSS, Home Subscriber Server, 41, 51, containing profiles relevant to subscriber, services and security, as is well known to a person skilled in the art. Each SIP server further includes a CSCF, Call State Control Function, 42, 52, operating as a call gateway and handling incoming calls and addressing, as also is well known to the skilled person. Connected to each SIP server is also a multicast relay server, here exemplified with JPIP relay servers 43 and 53.

According to the invention, each wireless terminal, or wireless multimedia device, 10, 11, 12, may operate either as an image server or image client, the latter case also referred to as image browser, in the context of an image data transfer session using a client-server protocol for interactive image data exchange. When using a JPIP protocol this involves configuring the terminal with an appropriate JPIP host software module 14, when used as a server, and a JPIP client software module 15, when used as a client for browsing images (modules 14 and 15 only being shown in FIG. 1 for terminal A). The host server 13 in FIG. 1 is a dedicated image server, for example a personal computer, capable of handling SIP-based sessions. This dedicated image server further includes appropriate JPIP host software.

The Session Initiation Protocol (SIP) is an application-layer signaling protocol defined by the Internet Engineering Task Force (IETF). It is a protocol that can establish, modify and terminate multimedia sessions or calls with one or more participants. These sessions can include IP-based videoconferences, Internet audio calls (VoIP), shared whiteboard, gaming sessions, multimedia distribution, etc. The entities involved in a SIP session may be referred to as client user agent and server user agent. Within the context of SIP, use is often made of protocol known as the Session Description Protocol, SDP. This is a text-based format used for describing media parameters and data carried by the SIP protocol. It can also be used for specifying client capabilities. In this respect, the SIP protocol itself, its basic session establishment, and the use of the SDP protocol, should be well known to a person skilled in the art within the field of SIP. In brief, in a basic SIP session establishment, a client user agent (UA) sends an INVITE request to a server user agent (UA). The server responds with a 200OK message; the client acknowledges this by sending ACK request.

JPIP is an application level protocol, such as HTTP or IMAP. It standardizes the way clients, wishing to exchange image-related data with the host server, form requests to servers as well as the responses generated by the server. It is a standardized protocol that allows efficient data transfer exploiting the features of JPEG 2000, and possibly other embedded codecs.

A JPEG 2000 image can be decoded in many ways. It may be decoded in full or in part, with varying resolutions, quality levels, regions, components, etc. Consider a typical scenario where high-quality, high-resolution digital images reside in a server. Clients, which may constitute a host of different terminals with varying capabilities, wish to view the images residing in the server. The clients need to interact with the server in order to exchange image data to surf and view the images.

To view a desired region with a certain resolution, size, location, component, layer, and other JPEG 2000 parameters for the image and imagery related data, the client issues a request to the server. A JPIP request message contains all the necessary information to request only enough data to decode part of the JPEG2000 image. The client may also search embedded XML metadata in the image. The server will respond by delivering imagery and image related data by means of a codestream. A JPEG2000 codestream is constructed so that the necessary data for decoding part of the image can be directly extracted form the codestream itself. This subset of the original codestream spawns another compliant codestream, which can be sent directly to the user. The protocol also allows for the negotiation of client and server capabilities and limitations. For more information on the structures of the client requests and the server responses, as well as its contents, reference is made to the JPIP standard prepared by ISO/IEC and ITU-T and currently available on www.jpeg.org.

Thus, it is necessary for JPIP-enabled browsing and surfing that the server, which is serving the JPIP requests, knows the capabilities of the client. These capabilities, which may include among other things the terminal's screen resolution, display color depth, decoder version/type, etc., are needed by the server to optimize the image related data that is to be transmitted back to the client. Hence, before the client actually requests the image data, the server should have the capabilities of the client.

The SIP client and the server can exchange the above described capabilities during the SIP session establishment. The preferences of a SIP caller may be expressed by means of Caller Preferences in SIP headers. The client and the server can also exchange and update these capabilities during the image browsing session, if necessary. For example, a client may be roaming and the connection properties may change during roaming. Alternatively, the caching capabilities of the client may change with time. In any case, the client should be able to update the server regarding these changes.

Thus, the image server and the browser will use the SIP session to negotiate the image session. The image session is described with the Session Description Protocol, SDP, which is carried as payload in the SIP messages. The client capabilities are in this context described by means of Caller Preferences.

A SIP User-Agent can indicate that it supports JPIP by including a feature tag (for example, type=“image/jpip” or g.jpip) as a Contact parameter. It is also possible to indicate support for server and client functionality (for example, g.jpip.server, g.jpip.client. A JPIP-enabled user agent can use these feature tags when initiating calls. For example, a SIP session is established only if a user agent of a prospective callee supports JPIP.

The session description provided by SDP can include several media (such as audio and video). The negotiated transport protocol can be UDP, TCP or HTTP. If HTTP is used, no SDP media is required but the referred HTTP URI is carried in the SIP headers. However, using HTTP requires that the device support an HTTP server.

In the following, simplified examples of different ways to express a JPIP image session using the SDP protocol is described. The examples are not complete SDPs but need to be appended with appropriate fields known to the skilled person. The ‘m=media session description’ may be the only session in the SDP description or may co-exist with other media, such as audio or video. Multiple image sessions can be presented by having several image mediums (m=line) in the SDP description. Multiple images can be listed by adding ‘a=jpip:target’ lines, each indicating a possible jpeg2000 file. The “i=” line can be used to represent information on the image, such as the title of the image or the actual file name. The “i=” line can be set according to the media type.

As an example, an SDP attribute “jpip” can be used to encode JPIP commands in the SDP. The SDP sent by a prospective JPIP/UDP client would then look like this:

v=0
o=surf 3241325 1 IN IP4 172.21.40.24
c=IN IP 172.21.40.24
t=0 0
m=image 32785 udp jpip
a=recvonly
a=jpip:cap=sf.44,config.mbit=4,config.flags=240

Here, we use the SDP attribute “recvonly” to indicate that the media line proposes a JPIP client only. The client can however upload images to the server.

A TCP session description could look as follows:

Image Source (Server):

v=0
o=surf 1090348330 2 IN IP4 10.1.1.1
s=-
c=IN IP4 10.1.1.1
t=0 0
m=image 1500 TCP jpip
a=sendonly
a=direction:passive IN IP4

Image Browser (Client):

v=0
o=surf 1090348330 2 IN IP4 10.1.1.2
s=-
c=IN IP4 10.1.1.2
t=0 0
m=image 9 TCP jpip
a=recvonly
a=direction:active IN IP4

An UDP session description could look like:

Image Source (Server):

v=0
o=surf 1090348330 2 IN IP4 10.1.1.1
s=-
c=IN IP4 10.1.1.1
t=0 0
m=image 1500 UDP jpip
a=sendonly

Image Browser (Client):

v=0
o=surf 1090348330 2 IN IP4 10.1.1.2
s=-
c=IN IP4 10.1.1.2
t=0 0
m=image 32799 UDP jpip
a=recvonly

There are many ways by which an HTTP connection can be described using SDP. The examples below use HTTP/TCP as the transport name. The control URL contains the absolute URI part of the HTTP request, which identifies the JPEG 2000 file. The server can also include ‘jpip:target’ attributes in its offer.

Image Source (Server):

v=0
o=surf 1090348330 2 IN IP4 10.1.1.1
s=-
c=IN IP4 10.1.1.1
t=0 0
m=image 8080 HTTP/TCP jpip
a=control:/prater.jp2
a=sendonly
a=direction:passive IN IP4

In response, the client informs the server that it has accepted the proposal. The port number 9 means that client uses an ephemeral port.

Image Browser (Client):

v=0
o=surf 1090348330 2 IN IP4 10.1.1.2
s=-
c=IN IP4 10.1.1.2
t=0 0
m=image 9 HTTP/TCP jpip
a=direction:active IN IP4
a=recvonly

In the following example, the server has three alternative images that the client can browse. The “sendonly” attribute indicates that the medialine proposes a JPIP server only.

m=image 1500 UDP jpip
a=sendonly
a=jpip:target=pike.jp2
a=jpip:target=bass.jp2
a=jpip:target=salmon.jp2

The following description includes the use of multiple media:

v=0
o=surf 1090348330 2 IN IP4 10.1.1.1
s=-
c=IN IP4 10.1.1.1
t=0 0
m=audio 16846 RTP/AVP 96
a=rtpmap:96 AMR/8000
m=video 9010 RTP/AVP 97
a=rtpmap:97
m=image 1500 UDP jpip
a=sendonly

There are several use cases and call flows for establishing JPIP/SIP-based Rich Call sessions. Some of these scenarios and the corresponding call flows are described below. However, it must be noted that the scope of the invention is not limited to the following use cases only. Rather, the scope of the present invention covers all underlying JPIP/SIP-based Rich Call sessions.

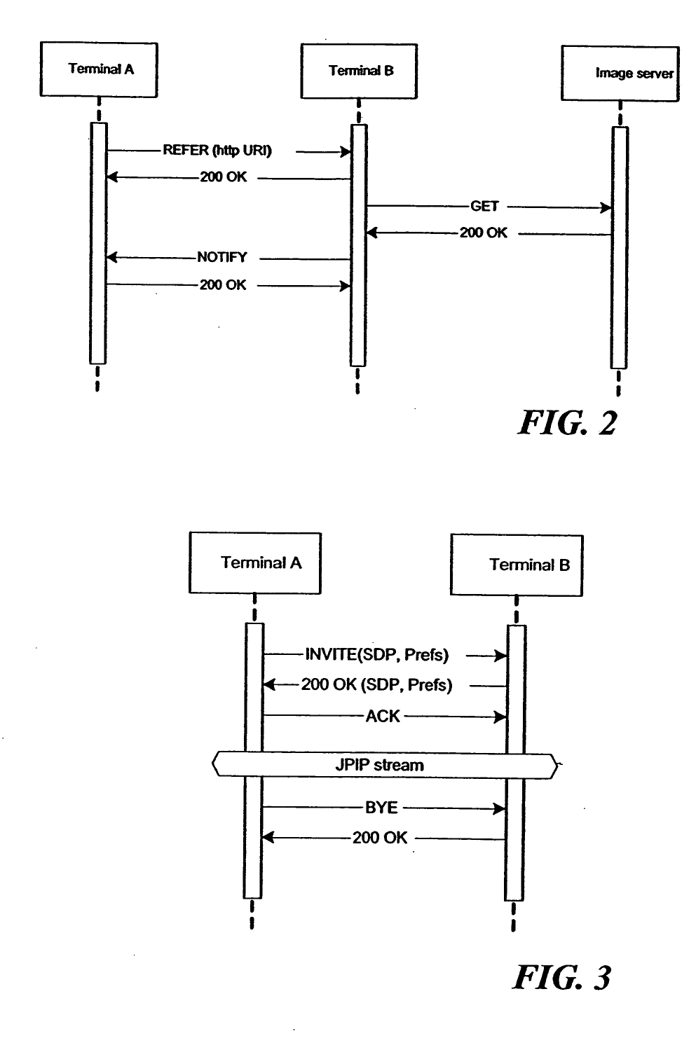

FIG. 2 shows an example when a user A, e.g. the terminal 11 in FIG. 1, refers another user B, e.g. the terminal 10 in FIG. 1, to an image stored by an image server, e.g. image server 13 in FIG. 1. In this case, user A REFER's other user B to the HTTP URI representing the JPIP image server. The example below shows only the relevant SIP headers and messages for this case:

| A → B: REFER sip:b@domain SIP/2.0 | |
|---|---|
| Refer-To: | |
| <http://jpip.example.net/u/a/my_pic.jp2?layers=1> | |
| Expires: 3600 | |
| B → A:SIP/2.0 200 Ok | |
| B → S: | GET /u/a/my_pic.jp2?layers=1 HTTP/1.1 |
| | Host: jpip.example.net |
| S → B: HTTP/1.1 200 Ok | |
| B → A: | NOTIFY sip:a@domain SIP/2.0 |
| | Subscription-State: |
| | terminated;reason=noresource |
| B → A: | SIP/2.0 200 Ok |

FIG. 3 shows an example when a user A (acting as server), e.g. the terminal 11 in FIG. 1, wants to share an image to be viewed by a user B (acting as client), e.g. the terminal 10 in FIG. 1. User A sends an INVITE request to user B indicating in the SDP the transport protocol to use:

INVITE sip:bob@brown.com SIP/2.0
Via: SIP/2.0/UDP 172.21.40.24
From: <sip:alice@wonderland.org>;tag=21523mf
To: <sip:bob@brown.com>
Call-ID: 00404c30-0000-1000-5c8e-7142bcb778a5
Cseq: 132873289
Contact:
<172.21.40.24:50600>;audio;video;+g.jpip.server;+g.jpip.cl
ient
Accept-Contact:
*;explicit;required;g.jpip.server;g.jpip.client
Content-Length: ...
v=0
o=surf 3241325 1 IN IP4 172.21.40.24
c=IN IP 172.21.40.24
t=0 0
m=image 1500 UDP jpip
a=sendonly
a=jpip:target=big-pike.jp2

User B (client) accepts the image sharing session:

SIP/2.0 200 Ok
Via: SIP/2.0/UDP 172.21.40.24
To: <sip:bob@brown.com>;tag=knxdFnoCu9
From: <sip:alice@wonderland.org>;tag=21523mf
Call-ID: 00404c30-0000-1000-5c8e-7142bcb778a5
Cseq: 132873289
Contact : <10.24.9.45>;audio;+g.jpip.server;+g.jpip.client
Content-Length: ...
v=0
o=bob 1283547326 1 IN IP4 10.24.9.45
c=IN IP 10.24.9.45
t=0 0
m=image 12451 udp jpip
a=recvonly
a=jpip:cap=sf.44,config.mbit=4,config.flags=240

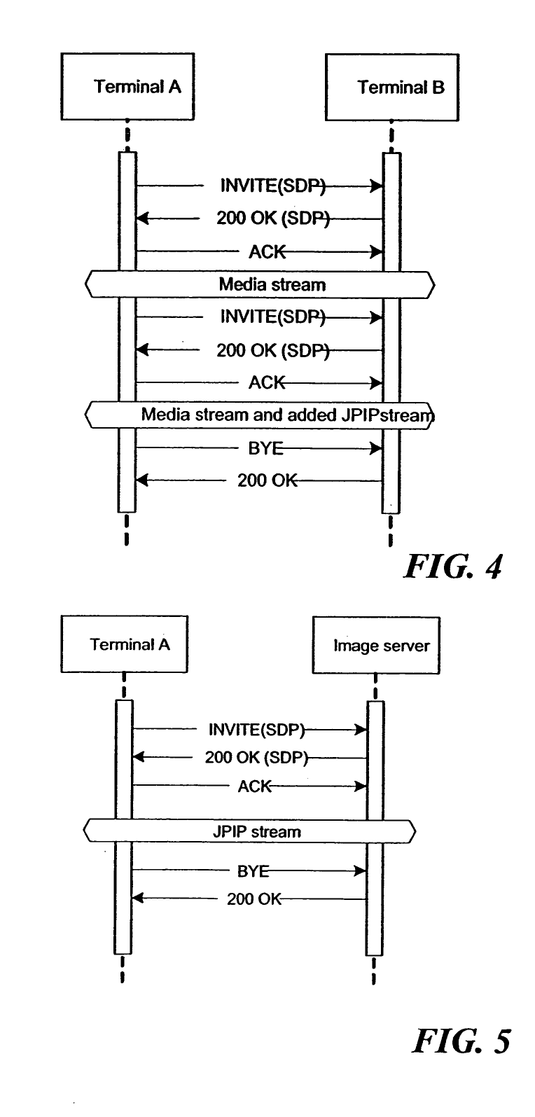

FIG. 4 shows an example when a user A, e.g. the terminal 11 in FIG. 1, wants to share an image during an existing SIP session. The user A sends a re-invite (INVITE request to existing call leg) with SDP of the existing session appended with image media.

INVITE sip:bob@brown.com SIP/2.0
Via: SIP/2.0/UDP 172.21.40.24
From: <sip:alice@wonderland.org>;tag=21523mf
To: <sip:bob@brown.com>;tag=212r5tjhuw
Call-ID: 00404c30-0000-1000-5c8e-7142bcb778a5
Cseq: 132873289
Contact:
<172.21.40.24:50600>;audio;video;+g.jpip.server;+g.jpip.cl
ient
Content-Length: ...
v=0
o=surf 3241325 5 IN IP4 172.21.40.24
c=IN IP 172.21.40.24
t=0 0
m=audio 32144 RTP/AVP 96
a=rtpmap:96 AMR/8000
m=image 32785 udp jpip
a=recvonly
a=jpip:cap=sf.44,config.mbit=4,config.flags=240

FIG. 5 shows an example when a user A, e.g. the terminal 11 in FIG. 1, wants to upload an image to a server. The user sends a SIP invite (INVITE) message to the server. The server, in turn, downloads the image and sends a BYE request to terminate the session. The user uses upload=method in the SIP URL. The server indicates the image SIP URL in contact (or call-info) field.

A JPIP session can also be initiated as part of an ongoing SIP conference. There are two ways to initiate an image session within the existing multiparty SIP session: 1) The image can be uploaded to a server and the URI be shared in the conference, or 2) the image server can reside in one of the conference participants' device and the conferencing server merely forwards the requests.

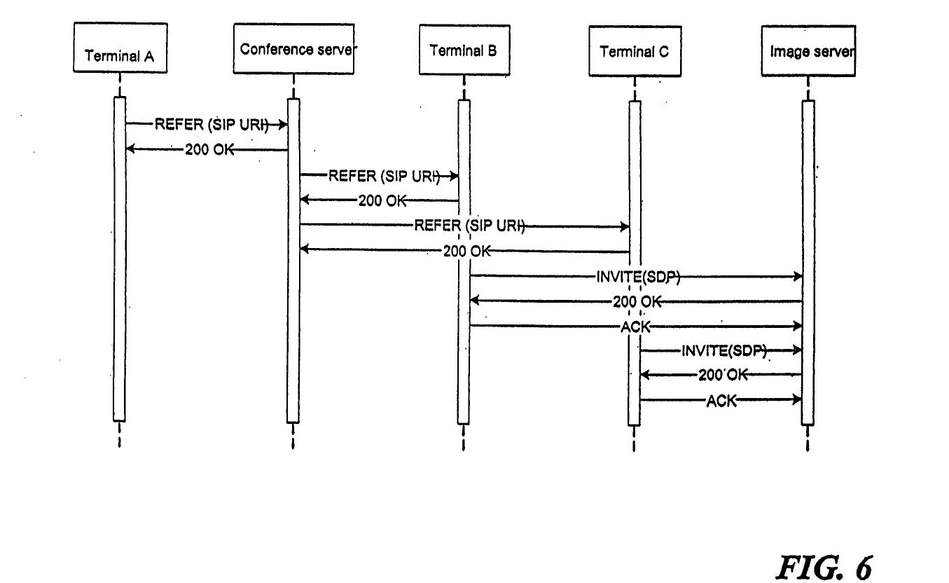

In the case of uploading to the server, the user uploads the image to the conferencing server (or any other server providing image storage) as described above. The user, e.g. the terminal A in FIG. 1, sends a REFER to the conference URL to indicate that the image can be found on the conferencing server. This is shown in FIG. 6, in which figure some of the messages have been omitted for the sake of simplicity.

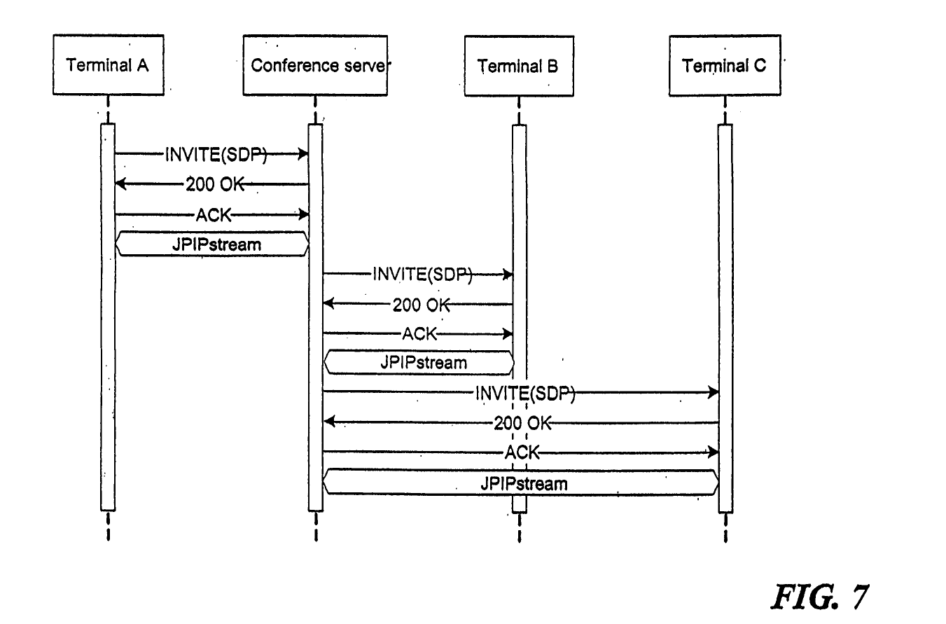

In the case of the image server residing on participants' device, e.g. terminal A in FIG. 1, the user will act as the image server and the conferencing server merely forwards the requests behaving as a proxy between conference members, e.g. terminals B and C in FIG. 1. The conferencing server can be optimized so that it fetches the full image right away and does not forward the request to the image server residing in the user's terminal A. The client, A, re-invites the conference call-leg with added image media by means of an INVITE. The server sends re-invites to other conference participants with the updated SDP. This example is shown in FIG. 7. Again, for sake of simplicity, some of the messages have been omitted.

As mentioned, the system of the present invention includes a multicast relay server. Referring again to FIG. 1, a multicast relay server 43, 53, here exemplified with a JPIP relay server, is connected to each SIP server. Such a relay server is network entity that acts as a multicast or group control unit in order to enable image sharing among multiple devices. This is achieved by having the device-originated browsing session send the session description through the multicast relay server that will intercept the message and add its own address and operate as an intermediate entity for multicasting for example JPIP messages to a plurality of devices.

With reference to FIG. 1, a simple example is of the operations is described. First, assume that terminal A initiates a SIP-based audio-only conference call session with other users, e.g. terminal B and C. Terminal A will send an invitation (INVITE) to the other terminals B and C requesting them to join him in the conference call. The necessary INVITE messages, along with the appropriate SDPs, may look like:

INVITE sip:Friend_B@net.fi
v=0 o=pep 28906 28908 IN IP4 126.6.6.4
s= On Shopping
i=A phone call for showing something
e=pep@net.fi
c=IN IP4 224.2.17.12
t=28733 28734
m=audio 491 70 RTP/AVP 0
INVITE sip:Friend_C@net.fi
v=0 o=pep 28906 28908 IN IP4 126.6.6.4
s= On Shopping
i=A phone call for showing something
e=pep@net.fi
c=IN IP4 224.2.17.12
t=28733 28734
m=audio 491 70 RTP/AVP 0

Once the SIP-based audio session is established, the users of the terminals communicate with each other in the conference call.

Now, consider the situation where the user of terminal A originating the call wishes to share an image with the other users, using JPIP as the image sharing protocol. Since the session is based on SIP, it is fairly easy to extend the scope of the media in the ongoing session by sending a re-invite (INVITE) message signal to the participating users. The audio-only conference session will be renegotiated to extend it for image surfing using JPIP by utilization of the JPIP relay server 43, having IP address 172.56.44.34 and ports 410-420. The JPIP relay server will be included in the SDP messages as an intermediate element by including a new “c=” field for the new media line. This new SDP type indicates the usage of JPIP in the modified call session. The new media line also includes the port numbers of the JPIP relay where the participating devices will contact for sending/receiving the JPIP messages. The messages from terminal A will look like:

INVITE sip:Friend_B@net.fi
v=0 o=pep 28906 28908 IN IP4 126.6.6.4
s= On Shopping
i=A phone call for showing something
e=pep@net.fi
c=IN IP4 224.2.17.12
t=28733 28734
m=audio 491 70 RTP/AVP 0
m=application 32416 udp JPIP
INVITE sip:Friend_C@net.fi
v=0 o=pep 28906 28908 IN IP4 126.6.6.4
s= On Shopping
i=A phone call for showing something
e=pep@net.fi
c=IN IP4 224.2.17.12
t=28733 28734
m=audio 491 70 RTP/AVP 0
m=application 32416 udp JPIP

The messages from JPIP relay server 43 to terminals B and C will look like:
INVITE sip:Friend_B@net.fi
v=0 o=pep 28906 28908 IN IP4 126.6.6.4
s=On Shopping
i=A phone call for showing something
e=pep@net.fi
c=IN IP4 224.2.17.12
t=28733 28734
m=audio 491 70 RTP/AVP 0
m=application 411 udp JPIP
c=IN IP4 172.56.44.34
INVITE sip:Friend_C@net.fi
v=0 o=pep 28906 28908 IN IP4 126.6.6.4
s=On Shopping
i=A phone call for showing something
e=pep@net.fi
c=IN IP4 224.2.17.12
t=28733 28734
m=audio 491 70 RTP/AVP 0
m=application 412 udp JPIP
c=IN IP4 172.56.44.34

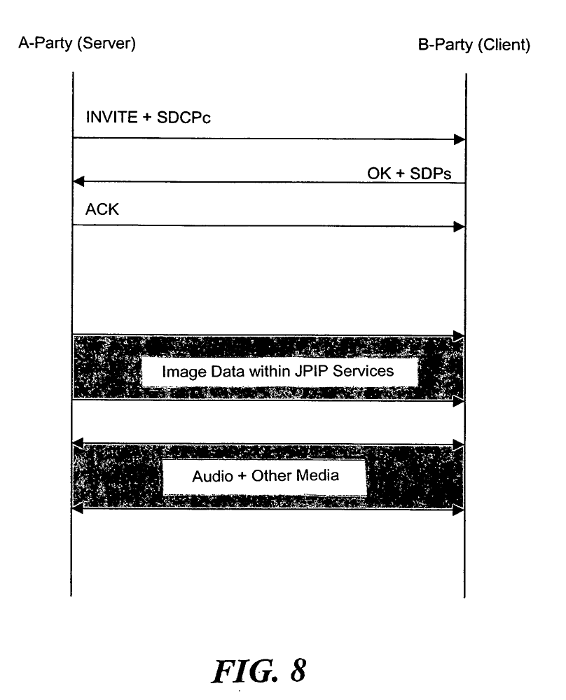

With reference to FIGS. 8-14, some examples of possible scenarios within the scope of the present invention will now be illustrated.

A first example illustrates a “host-initiated host-controlled image surfing”. In this example a communication session is established between a host (server) and one or more clients using a SIP-based rich call. The host can be any multimedia device capable of acting as a host server for JPIP-enabled SIP-based sessions. The client, likewise, can be any compliant multimedia device capable of participating in this image sharing session.

The rich call session is always initiated by the host (A-Party) terminal, which also hosts the image. The call is acknowledged by one or more participating clients and the session is established. The session specifications may change at any time during the rich call session. Any number of clients may join or leave the multimedia session.

Image surfing is controlled by the A-party while the client terminals (B-party) see, in real-time, what the A-party is surfing. Real-time interactivity can be achieved by using real-time speech interaction between the participating users to request services or to provide supplementary information to the other users. Image interactivity is achieved by issuing requests and services between the clients and the server using JPIP. FIG. 8 illustrates the call session mechanism.

Consider the scenario where a user (A-party) takes a high-quality, high-resolution picture with an imaging phone, and wishes to share his picture with other mobile users (B-party), which can be either a single user or multiple users. Since the captured image cannot be adequately displayed on the small screen displays of the B-parties' mobile phone users, A-party decides to use image surfing to share the image. He initiates a Rich Call to the B-party, some of whom accept his request to share the image.

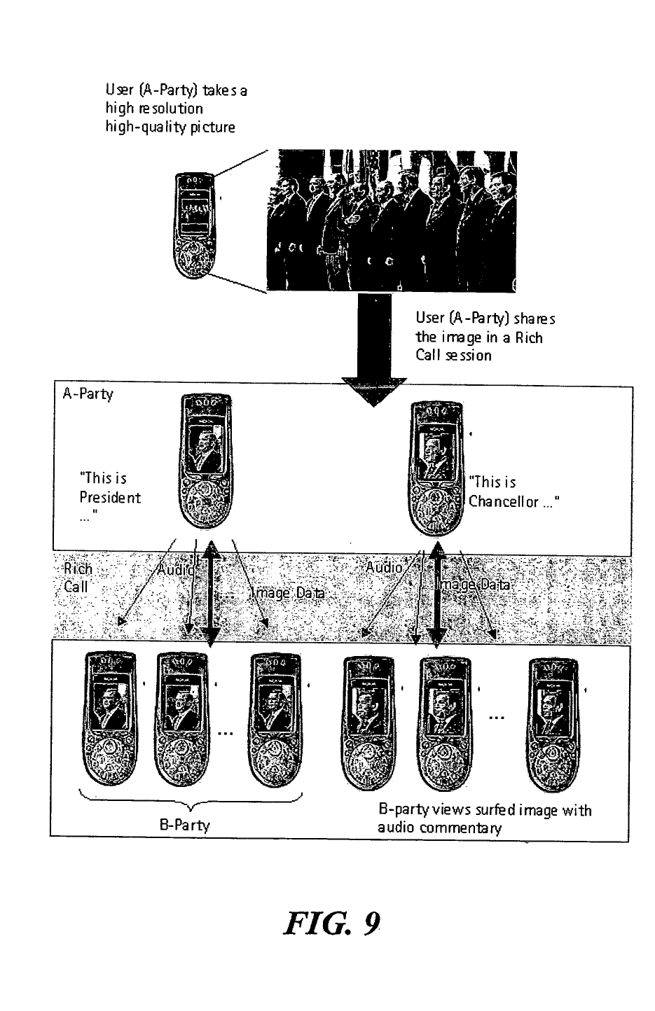

Once connected, A-party surfs through the image on his phone while commenting on the parts of the image in view. The B-party share the same view as the A-party while at the same time listening to the comments of the A-party relevant to the image portion in display. A-party can show the picture in full detail while at the same time stressing on the regions of interest and adding voice explanations to it. FIG. 9 illustrates one such scenario.

A second example illustrates a “client-controlled image surfing”. In this example a communication session is again established between a host (server) and one or more clients using a SIP-enabled rich call. The host can be any multimedia device capable of acting as a host server for JPIP-enabled SIP-based sessions. The client, likewise, can be any compliant multimedia device capable of participating in this image sharing session.

The rich call session is initiated by either the host (A-Party) terminal or the client (B-party) terminal. The images reside in the A-party terminal. The call is acknowledged by the called users and the session is established. The session specifications may change at any time during the rich call session. Any number of clients may join or leave the multimedia session.

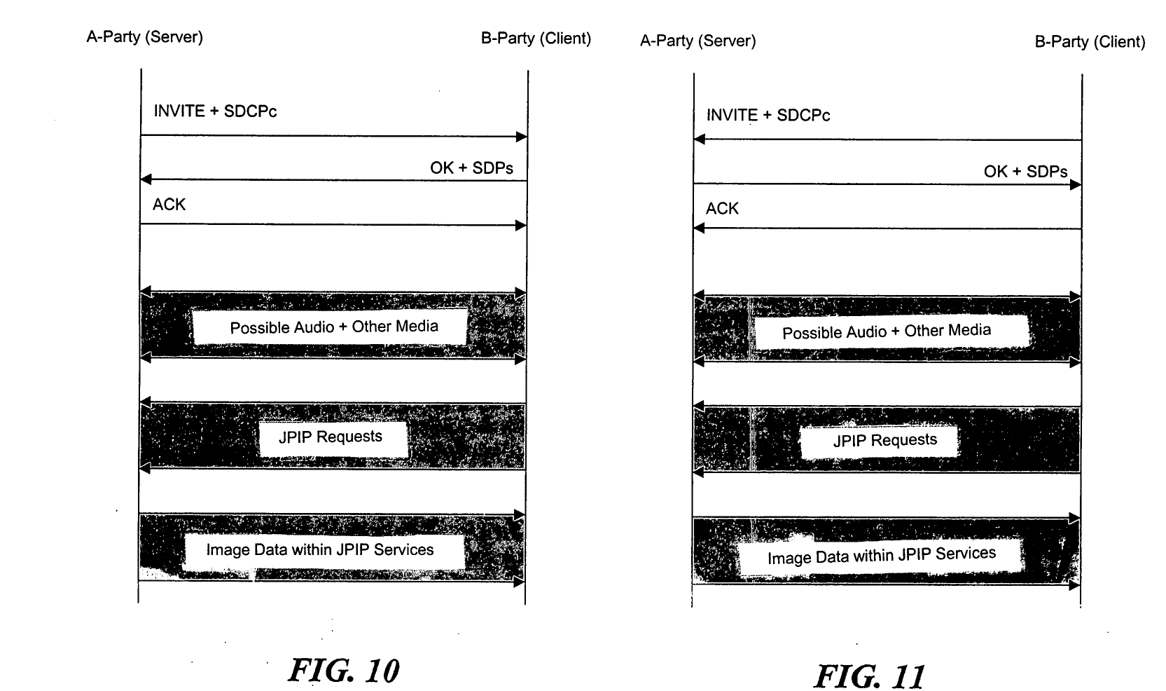

Image surfing is controlled by the B-party while the A-party is oblivious to the underlying surfing and is free to process other services. There can be any number of B-party clients, each one surfing independently of each other. Image sharing is not in real-time between the client and the host server because the client can surf the image independently of the server. Image interactivity is achieved by the client by issuing requests to the server using JPIP, and the server responding to the requests accordingly. FIG. 10 illustrates the call session mechanism.

Consider the scenario where a user (A-party) takes a high-quality, high-resolution picture with an imaging phone, and wishes to share his picture with other mobile users (B-party), which can be either a single user or multiple users. Since the captured image cannot be adequately displayed on the small screen displays of the B-parties' mobile phone users, A-party decides to use image surfing to share the image. He initiates a Rich Call to the B-party, some of whom accept his request to share the image.

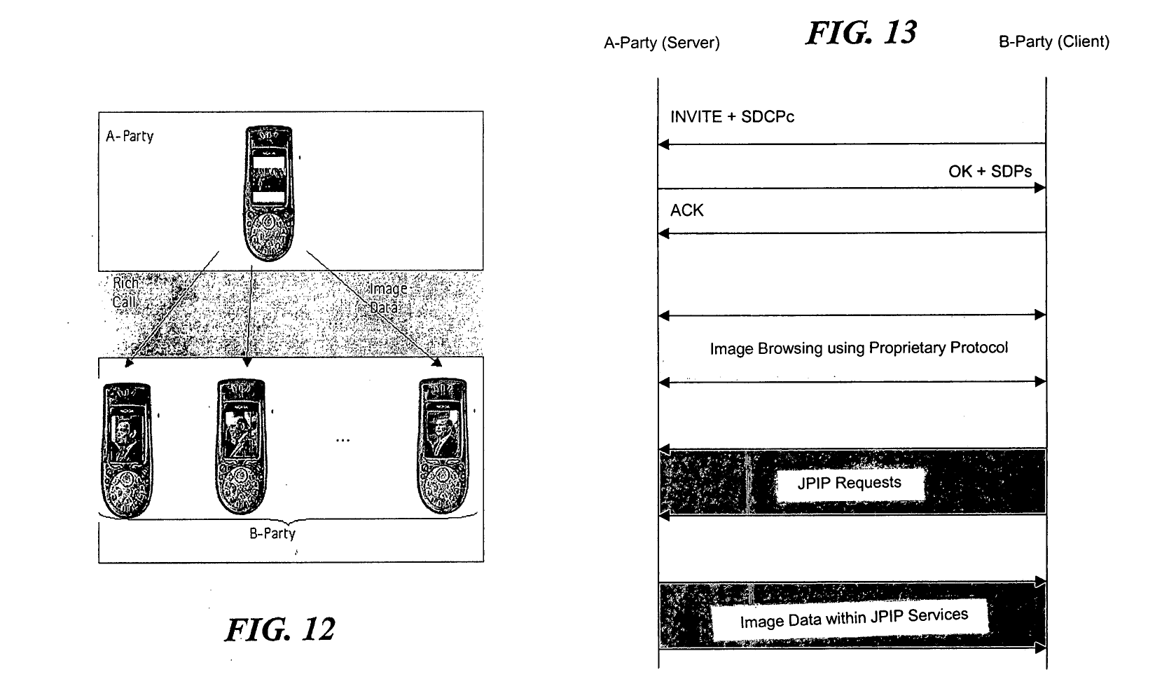

Once connected, A-party tells the B-party to surf the image in question. This signaling can be in any media format, such as text or speech. B-party then surfs the image residing in the A-party's terminal. Note that A-party is not participating in the surfing and is free to do some other work while its terminal is serving the requests received from B-party. The different B-party members can surf the same image independently of each other. FIG. 12 illustrates one such scenario.

It is also quite possible that some B-party user may initiate the Rich Call to the A-party and request permission to surf images residing in the A-party's terminal. In either case, it is only the B-party that is actually surfing the images residing in the host terminal of A-party. FIG. 11 illustrates the call session mechanism for this case.

A third example illustrates a “client-initiated dedicated-server image browsing and surfing”. In this example a communication session is again established between a host (server) and one or more clients using a SIP-enabled rich call. The host is a dedicated image server (e.g., PC) capable of handling JPIP-enabled SIP-based sessions. The client, on the other hand, can be any compliant multimedia device capable of participating in this image sharing session.

The rich call session is always initiated by the client (B-party) terminal while the images reside in the A-party terminal. The call is acknowledged by the dedicated server and the session is established. The session specifications may change at any time during the rich call session. Any number of clients may join or leave the multimedia session.

The participating client browses through the set of images residing in the dedicated server and selects the image to surf. Image surfing is controlled by the B-party while the A-party only serves the client requests. There can be any number of B-party clients, each one surfing independently of the other. Image sharing is not in real-time between the client and the host server. Image interactivity is achieved by the client by issuing requests to the server using JPIP, and the dedicated server responding to the requests accordingly. FIG. 13 illustrates the call session mechanism.

The server can be any storage terminal where images are stored. Typically, any sufficiently resourceful PC can act as a server but this may not necessarily be the case. So, for instance, a surveillance camera used to capture and possibly store images at specific locations can act as a server. Nokia Observation Cameras are one such example.

Consider the scenario where a dedicated image server (A-party) hosts a database of high-quality, high-resolution pictures. These pictures were taken using various image acquisition devices, such as digital camera, imaging phone, etc. and transferred to the image server. Different users have subscribed to the Image Browsing and Surfing Service offered by the dedicated image surfer.

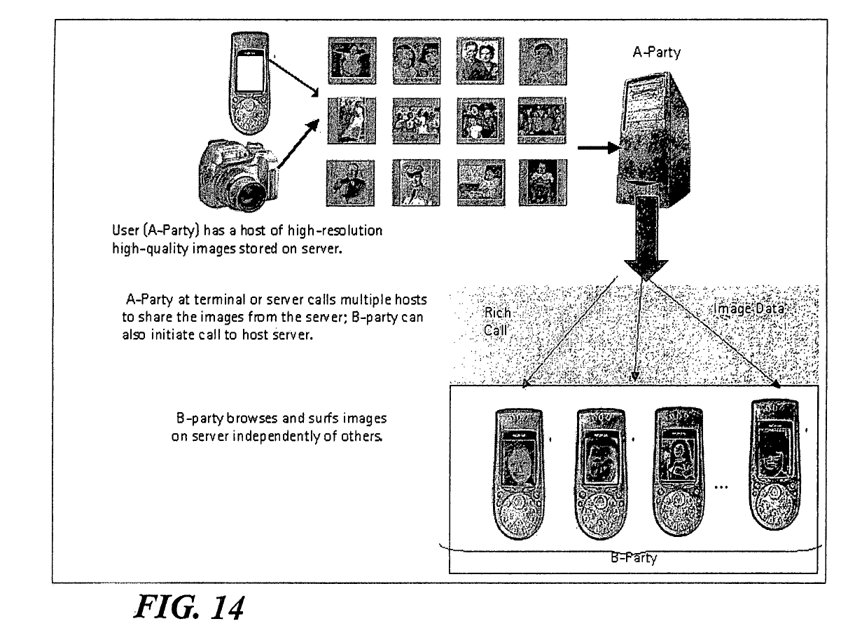

A mobile phone user (B-party) wants to access the images stored in the image server. The B-party user initiates a Rich Call to the A-party (server) and establishes the SIP-based session. Once connected, B-party browses through the thumbnails of the images residing in the server and selects the desired one. (A proprietary browsing protocol may be used for browsing purposes) Since the selected image cannot be adequately displayed on the small screen display of the B-party, the server decides to use image surfing to share the image. Using JPIP, B-party requests the desired regions of the image from the server, which are accordingly serviced back by the server. The user surfs the image as desired. FIG. 14 illustrates a typical scenario.

The JPIP/SIP-based call sessions of the present invention will be operable under various frameworks, some of which have been described in the exemplifying embodiments above. However, it should be noted that any call session that employs JPIP-based SIP-enabled rich call session for interactive image sharing falls under the scope of the invention.

1. A method for managing exchange of images and image related data between a client and a server, of which at least one is a wireless terminal, the method comprising:
establishing a Session Initiation Protocol, SIP, session between at least two end points formed by the client and the server; and
initiating an image data transfer session using a client-server protocol for interactive image data exchange within the established SIP session.

2. The method as claimed in claim 1, including, prior to said initiating step, a step of:
informing the server of the client's image related capabilities using the SIP session.

3. The method as claimed in claim 1, wherein the image data exchange is interactive such that it involves issuing requests for image related data, and responses to these requests.

4. The method as claimed in claim 1, wherein the client-server protocol is a protocol of the kind that provides the client with the ability to retrieve only selected portions of an image stored by the server, such as image data for a specific image region or image quality.

5. The method as claimed in claim 4, wherein the image is stored by the server side, and wherein the portions of the image to be transferred to the client are selected by the server side.

6. The method as claimed in claim 4, wherein the image is stored by the server side, and wherein the portions of the image to be transferred to the client are selected by the client side.

7. The method as claimed in claim 1, including configuring the wireless terminal to act as the client when using the client-server protocol.

8. The method as claimed in claim 1, including configuring the wireless terminal to act as the server when using the client-server protocol.

9. The method as claimed in claim 1, wherein the image data transfer session is initiated as part of an existing SIP conference resulting from said step of establishing a SIP session.

10. The method as claimed in claim 1, wherein the image data transfer session is a JPEG2000 Interctivity Protocol, JPIP, session.

11. The method as claimed in claim 1, wherein the step of initiating an image data transfer session is performed by a server side multicast relay server for multicasting session messages to a plurality of clients.

12. A system for managing exchange of images and image related data between a client and a server, the system including:
a client and a server, of which at least one is a wireless terminal;
means for establishing a Session Initiation Protocol, SIP, session between at least two end points formed by the client and the server; and
means for initiating an image data transfer session using a client-server protocol for interactive image data exchange within the established SIP session.

13. The system as claimed in claim 12, including means for informing the server of the client's image related capabilities using the SIP session.

14. The system as claimed in claim 12, wherein the image data exchange is interactive such that the client is configured to issue requests for image related data, and the server configured to respond to these requests.

15. The system as claimed in claim 12, wherein the client-server protocol is a protocol of the kind that provides the client with the ability to retrieve only selected portions of an image stored by the server, such as image data for a specific image region or image quality.

16. The system as claimed in claim 12, wherein the wireless terminal is configured to act as the client when using the client-server protocol.

17. The system as claimed in claim 12, wherein the wireless terminal is configured to act as the server when using the client-server protocol.

18. The system as claimed in claim 12, wherein the image data transfer session is a JPEG2000 Interctivity Protocol, JPIP, session.

19. The system as claimed in claim 12, including a multicast relay server for multicasting session messages of the image data transfer session to a plurality of clients.

20. A wireless terminal managing exchange of images and image related data between a client and a server, of which at least one is the wireless terminal, the terminal comprising:
means for establishing a Session Initiation Protocol, SIP, session between the terminal and another end point formed by the client or the server; and
means for initiating an image data transfer session using a client-server protocol for interactive image data exchange within the established SIP session.

21. The terminal as claimed in claim 20, wherein the image data exchange is interactive such that the client is configured to issue requests for image related data, and the server configured to respond to these requests.

22. The terminal as claimed in claim 20, wherein the client-server protocol is a protocol of the kind that provides the client with the ability to retrieve only selected portions of an image stored by the server, such as image data for a specific image region or image quality.

23. The terminal as claimed in claim 20, wherein the wireless terminal is configured to act as the client when using the client-server protocol and to select the portions of the image to be transferred to the terminal from the server.

24. The terminal as claimed in claim 23, wherein the terminal is configured to establish the SIP session with the server.

25. The terminal as claimed in claim 23, wherein the terminal is configured to inform the server of the terminal's image related capabilities using the SIP session.

26. The terminal as claimed in claim 20, wherein the wireless terminal is configured to store an image, act as the server when using the client-server protocol, and to select the portions of the image to be transferred to the client from the terminal.

27. The terminal as claimed in claim 26, wherein the terminal is configured to establish the SIP session with the client.

28. The terminal as claimed in claim 20, wherein the image data transfer session is a JPEG2000 Interactivity Protocol, JPIP, session.
